(19) United States
(12) Patent Application Publication
(10) Pub. No.: US 2013/0285431 A1
(43) Pub. Date: Oct. 31, 2013

(54) REAR HEADREST MECHANISM USED IN THE PASSENGER SEATS OF MOTOR VEHICLES

(71) Applicants: Massimo TURLETTI, Bursa (TR); Gökhan Oral, Bursa (TR)

(72) Inventors: Massimo TURLETTI, Bursa (TR); Gökhan Oral, Bursa (TR)

(73) Assignee: MARTUR SUNGER VE KOLTUK TESISLERI TICARET VE SANAYI ANONIM SIRKETI, Bursa (TR)

(21) Appl. No.: 13/852,638

(22) Filed: Mar. 28, 2013

(30) Foreign Application Priority Data
Apr. 26, 2012 (TR) 2012/04880

(51) Int. Cl. B60N 2/48

(52) U.S. Cl. CPC B60N 2/4873
USPC 297/391

(57) ABSTRACT

A rear headrest mechanism used in the motor vehicles enables the passenger to bring said headrest to use position by discomforting the back of the passenger in the non-use position.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a rear headrest mechanism used in the motor vehicles enabling the passenger to bring said headrest to use position by discomforting the back of the passenger in the non-use position.

The present invention relates to a rear headrest mechanism used in the motor vehicles giving rise to bringing again of said headrest by the passenger to use position by discomforting the back of the passenger in the non-use position, partially entering into the seat body when a downward pressure is applied and then self-returning to the non-use position.

2. Description of Related Art Including Information Disclosed Under 37 CFR 1.97 and 37 CFR 1.98

Nowadays, rear headrests on which passenger rests their head is used especially in passenger cars, light commercial vehicles and other motor vehicles carrying passengers. Said headrests provide a more comfortable and a safe journey for the passenger by being brought to the proper position during use. Rear headrests are mounted so as to be movable on the seats and during use the passenger brings thereof to the use position by manually moving the rear headrest with respect to the seat. Various rear headrest mechanisms are used for moving the headrest with respect to the seat. However, number of detail parts of the existing mechanisms is very high, therefore, installation is difficult and installation time is long. In addition, the risk of noise generation during driving is higher in said headrest the mechanisms. Manufacturing should be carried out with narrow tolerances as the headrest mechanisms have complex structure.

Most of the currently used rear headrests do not create the need for bringing the headrest to use position as they do not sufficiently discomfort the user in non-use positions. Thus, headrest is not generally brought to the use position. Said situation poses a drawback in terms of both safety and comfort.

No patent application similar to the rear headrest mechanism according to the present invention could be found. There are patent applications available in the respective art. The patent application No. 2009/08795 registered in the Turkish Patent Institute Register relates to a foldable headrest developed for being implemented to the passenger seats used for traveling of people with disabilities, providing space saving and viewing angle by being folded when required and enabling passengers to rest their heads in a comfortable position by being unfolded when required. The patent application No. 2006/01403 registered in the Turkish Patent Institute Register relates to a resting support implemented particularly to the headrests of the vehicle seats used in transportation vehicles or the armchairs used in homes, wherein it comprises a support body for the user's head, movable resting supports placed on both sides of said support body and a horizontal spindle articulated to the resting supports by mechanical joints so as to rotate around a horizontal axis and connected to the back portion of the respective seat. Right and left parts of the seat headrest, if required, lean forward 90° independently from each other and provide support for user's head through both sides or one side thanks to the independent mechanical joints articulated to the resting supports.

### BRIEF SUMMARY OF THE INVENTION

The object of the present invention is to develop a rear headrest mechanism used in the motor vehicles enabling the passenger to bring said headrest to use position by discomforting the back of the passenger in the non-use position.

Another object of the present invention is to reduce the number of detail parts as compared to the existing mechanisms, thus, facilitating installation and reducing installation time. Another object of the present invention is to provide ease of manufacturing and increased mass production speed.

Another object of the present invention is to reduce the risk of noise generation during driving.

Another object of the present invention is to enable manufacturing with a wide range of tolerances thanks to the developed mechanism.

### BRIEF DESCRIPTION OF THE SEVERAL VIEWS OF THE DRAWINGS

FIG. 1 is the perspective exploded view of the headrest mechanism.

FIG. 2 is the perspective view of the rear headrest mechanism.

FIG. 3 is the perspective view of the mechanism with the headrest in the front.

FIG. 4 is the perspective view of the headrest in use position.

FIG. 5 is the perspective view of the mechanism during installation of cam tensioner springs.

FIG. 6 is the perspective view of the mechanism during lowering of the headrest.

FIG. 7 is the perspective view of the mechanism when headrest is not used.

FIG. 8 is the side view of the mechanism when the headrest is in non-use position.

FIG. 9 is the side view of the mechanism when the headrest is raised to be used.

FIG. 10 is the side view showing the cams advancing through the body.

FIG. 11 is the side view of the mechanism when the headrest is brought to the use position.

FIG. 12 is the side view of the mechanism when the headrest is in non-use position.

FIG. 13 is the general perspective view of the headrest mechanism.

FIG. 14 is the general perspective view of the rear headrest connected on the seat and back portion thereof.

FIG. 15a is the view of the passenger position when the headrest is brought to the use position.

FIG. 15b is the view of the passenger position when the headrest is brought to the non-use position.

FIG. 16a is the entire rear right view of the stopper upon contact thereof with the cartridges.

FIG. 16b is the rear right and closer view of the stopper upon contact thereof with the cartridges.

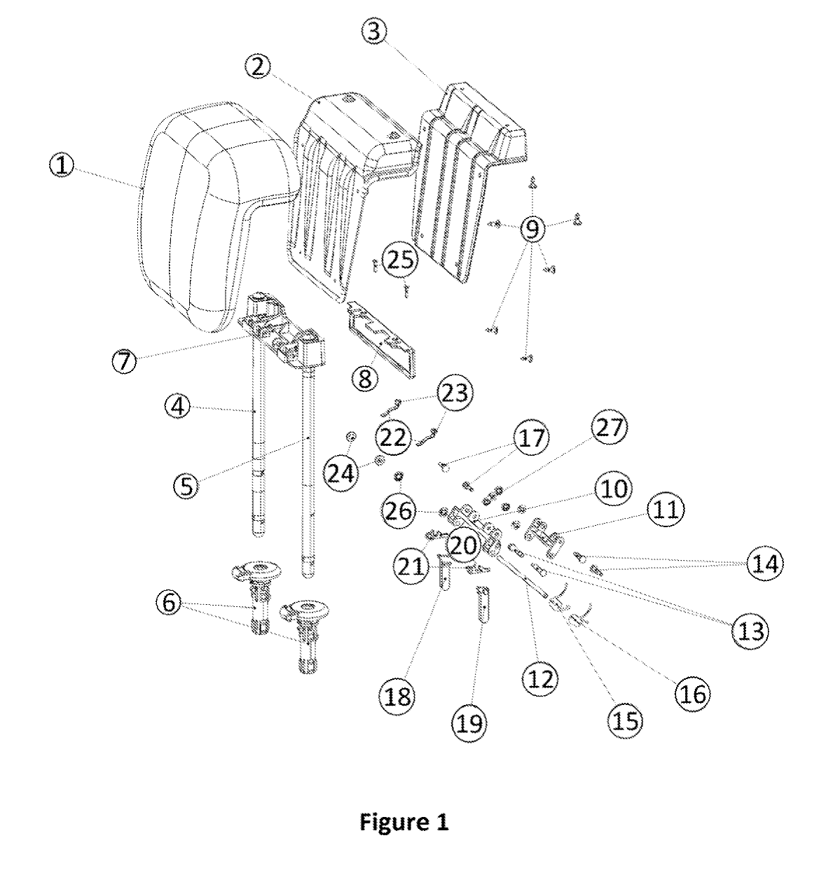

### REFERENCE NUMBERS

1. Headrest foam

2. Upper headrest plastic

3. Lower headrest plastic

4. Right headrest shaft

5. Left headrest shaft

6. Headrest cartridge

7. Body

8. Rear Cover

9. Headrest bolt

10. Front connecting rod

11. Rear connecting rod

12. Front connecting rod central pin

13. Front connecting rod headrest connection pin

14. Rear connecting rod headrest connection pin

15. Right headrest drive spring

16. Left headrest drive spring

17. Rear connecting rod central pin

18. Right cam

19. Left cam

20. Reference guide

21. Reference guide pin

22. Cam tensioner spring

23. Rivet connection

24. Bushing

25. Connecting bolt

26. Front connecting rod central pin ring

27. Connecting rod ring

28. Stopper

### DETAILED DESCRIPTION OF THE INVENTION

The present invention relates to a rear headrest mechanism used in the motor vehicles enabling the passenger to bring said headrest to use position by discomforting the back of the passenger in the non-use position.

A brief explanation of the two different functions of the present invention is as follows. Movable rear headrest mechanism integrated on the passenger seats protrudes outward so as to discomfort the passenger's back in the non-use positions. For this reason, first, the passenger manually moves the headrest upward and then pushes said headrest to back so that it is aligned with the seat surface. In order to bring said headrest to non-use position, said headrest is lowered and it moves to the initial position thereof by protruding outwardly from the seat surface.

The rear headrest mechanism according to the present invention comprises a headrest foam (1) providing comfort and ergonomic requirements of the headrest. An upper headrest plastic (2) is used for ensuring creation of the form of said headrest foam (1) and protection thereof. Connection of the headrest with the connecting rods (10, 11) is provided by a lower headrest plastic (3).

Right and left headrest shafts (4, 5) are used to set the headrest course. Integration of the rear headrest mechanism to different seats can be provided by changing the length of the right and left headrest shafts (4, 5) and in addition, ability of the headrest operating in different courses is also provided. A headrest cartridge (6) is used for guiding the movement of the right and left headrest shafts (4, 5) and for mounting of the headrest to the seat. A plastic based body (7) is used in order to protect the headrest mechanism from external impacts.

A rear cover (8) preventing the headrest to be seen in non-use position by confining the mechanism into the body (7) is used. A headrest bolt (9) is used for the installation of the headrest when putting on the slipcover.

Front and rear connecting rods (10, 11) are used for moving the headrest. A front connecting rod central pin (12) is used as the center of rotation of the front connecting rod (10). Front connecting rod headrest connection pin (13) forms the center point on which the headrest and the front connecting rod (10) rotate around each other. Rear connecting rod headrest connection pin (14) forms the center point on which the headrest and the front connecting rod (11) rotate around each other. Said rotary motion is provided by the right and left headrest drive springs (15, 16). Rear connecting rod central pin (17) serves as the center of rotation of the rear connecting rod (11).

Right and left cams (18,) are used for providing the transition of the headrest between the use positions. Reference guide (20) is the part keeping the right and left cams (18, 19) in non-use position. When the right and left cams (18, 19) are freed from the reference guide (20), right and left headrest drive springs (15, 16) are used to enable the headrest to move to non-use position (front and rear connecting rods (10, 11) to rotate around each other). Reference guide pin (21) is used for enabling relative movement of the reference guide (20) with the front and rear connecting rods (10, 11). Cam tensioner spring (22) is used to enable keeping the right and left cams (18, 19) so as to constantly bear against the reference guide (20).

A bushing (24) is used during the connection of the cam tensioner spring (22) to the body (7). Connecting bolt (25) is used to mount the rear cover (8) to the body (7). A front connecting rod central pin ring (26) and a connecting rod ring (27) serving as connecting elements for retraction of the mechanism are used.

Transition of the headrest to use position can be described as follows:

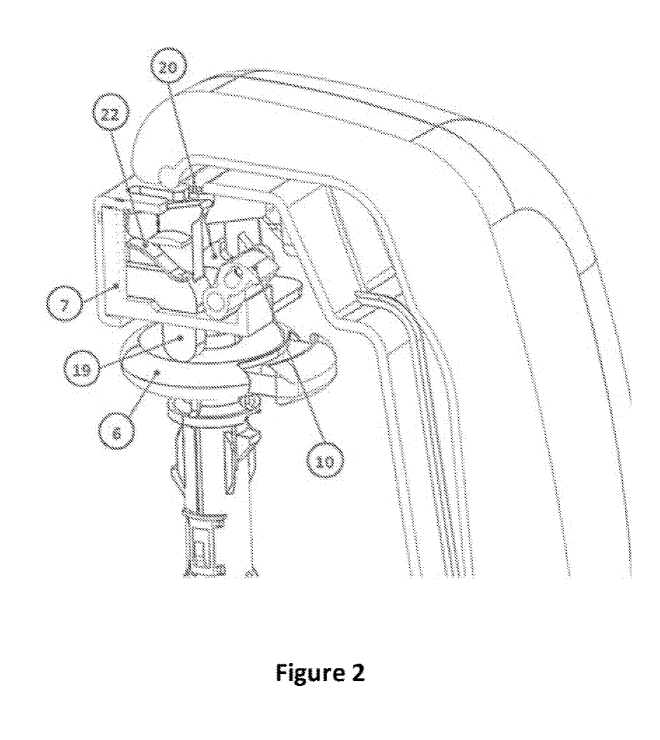

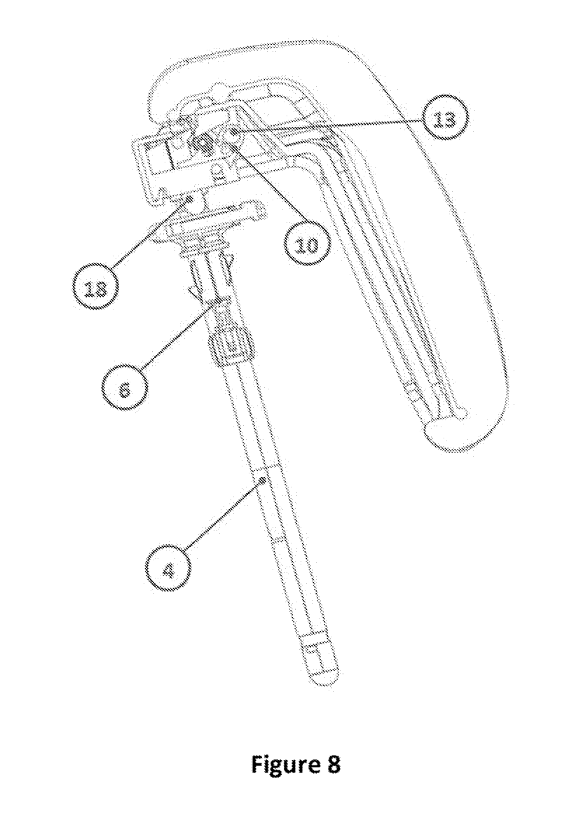

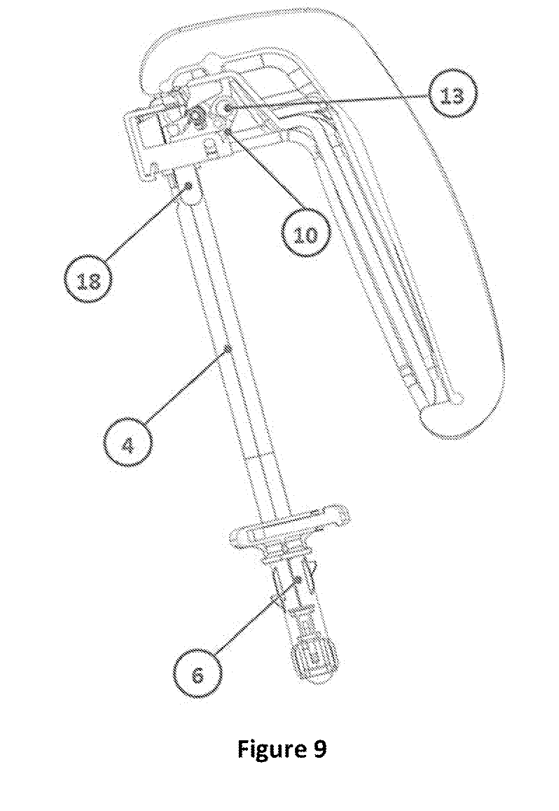

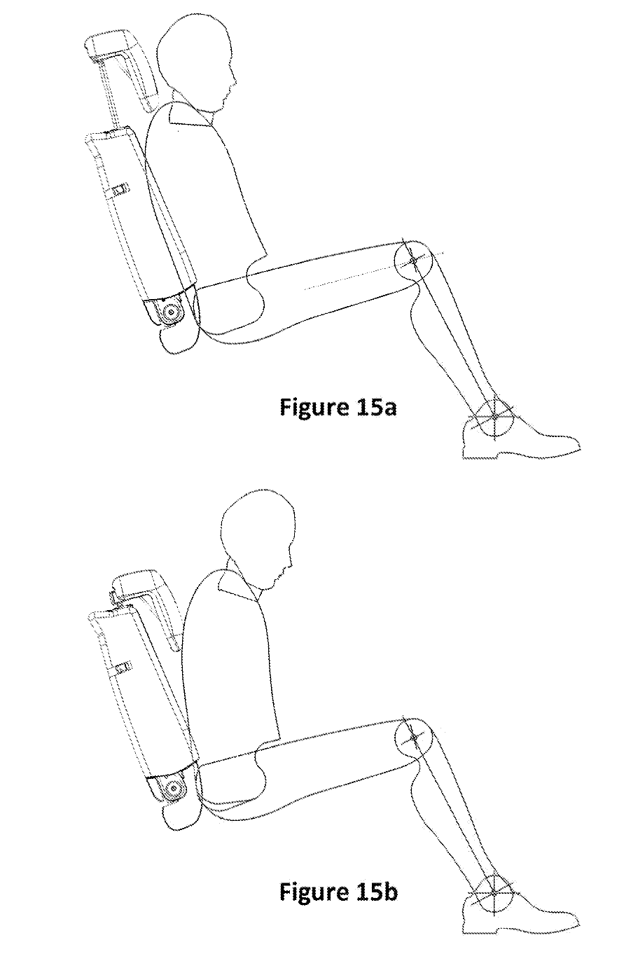

The headrest moves to the lower non-use position in the vehicle (FIG. 8). Said position is provided by a particular system designed for discomforting the passenger when seating upon contact of the headrest to the back thereof (FIG. 2, FIG. 15b). The passenger manually moves the headrest to an appropriate position not causing any discomfort to the user and set by the right and left headrest shafts (4, 5) and the headrest cartridges (6) (FIG. 9).

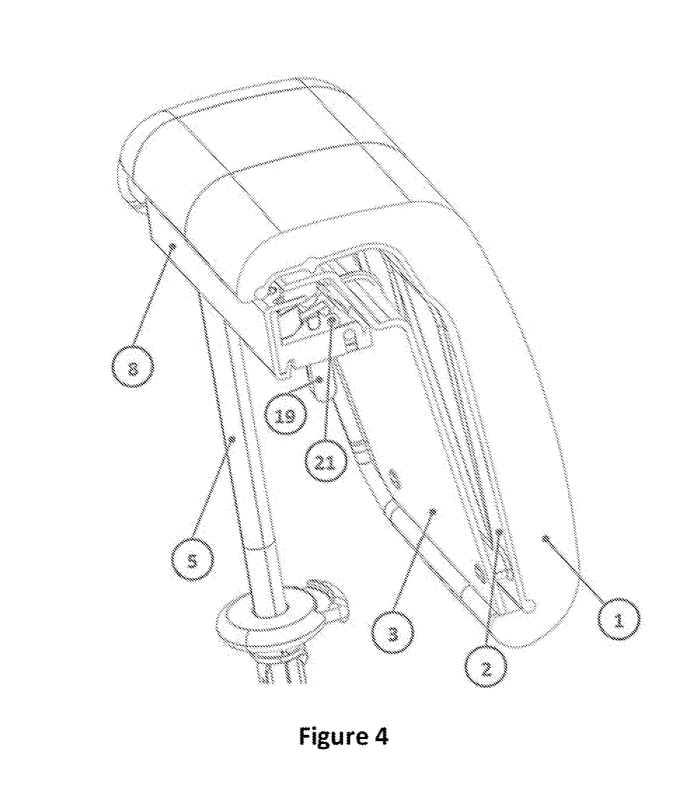

The headrest has two positions and the course thereof is 170 mm. When the passenger brings the headrest to the highest allowed point possible, the wires provided in the headrest cartridges (6) enter into the slots of the headrest shafts (4, 5) and enable the headrest to be maintained in said position. In said position, the headrest has yet moved to the use position. Lastly, the passenger pushes the headrest backward and enables the headrest to move to use position (FIG. 4).

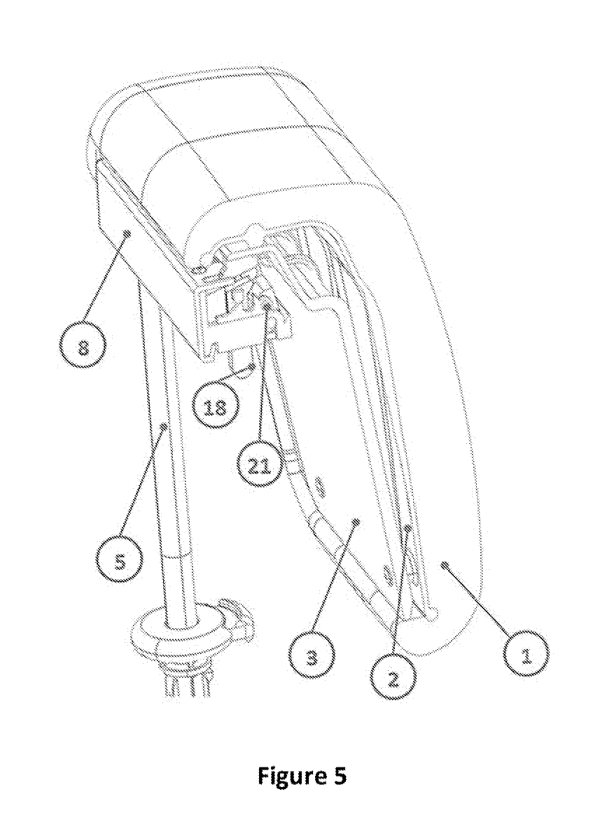

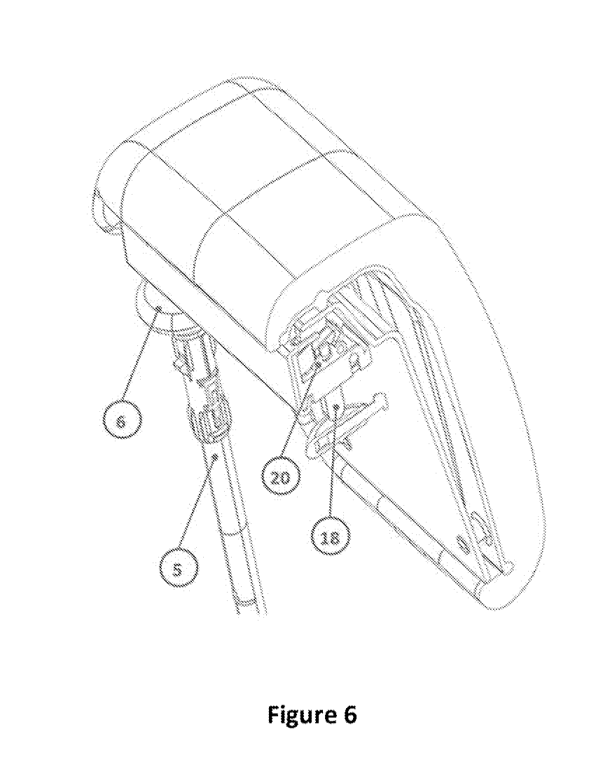

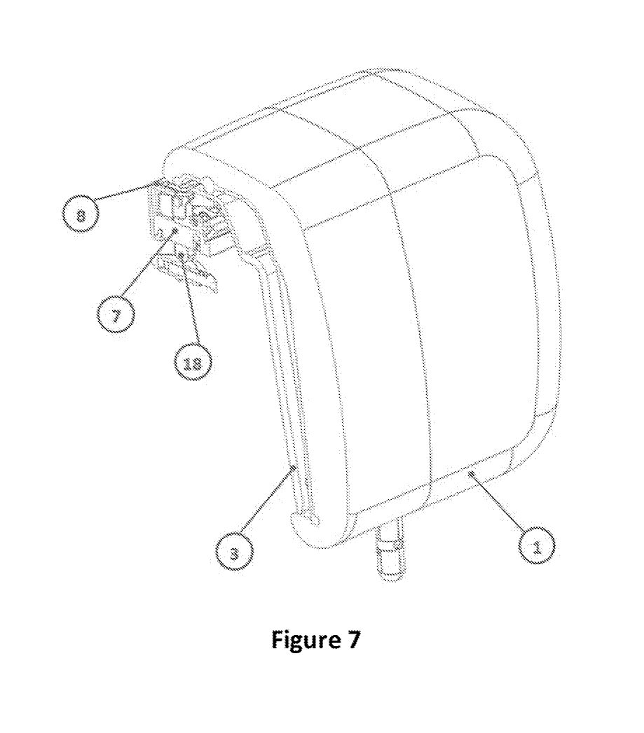

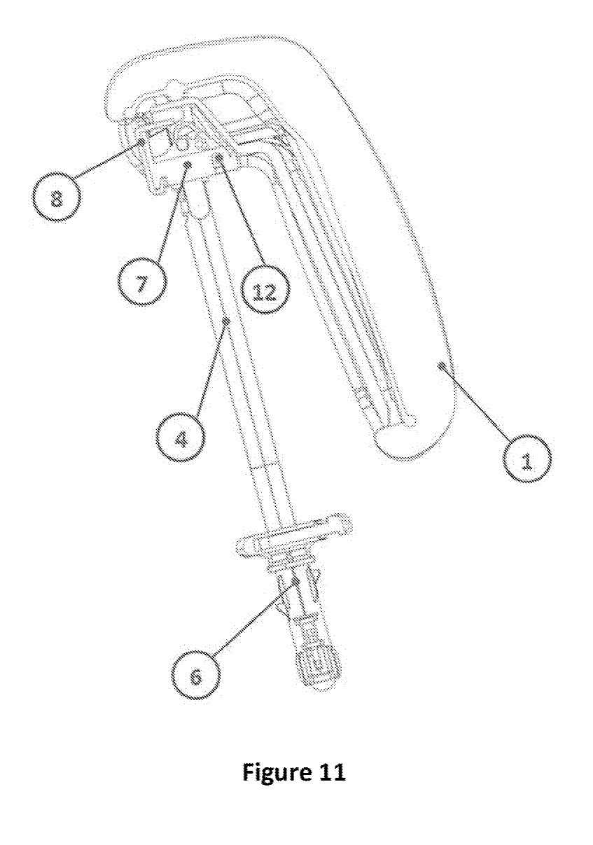

During the passenger's pushing of the headrest back and bringing of it to use position, lower headrest plastic (3) rotates the front and rear connecting rods (10, 11) while moving to the use position. Rotating connecting rods (10, 11) drive the reference guide pins (21) moving in the cocoon provided thereon. Reference guide pins (21) move together with the reference guides (20). The cams (18, 19) move by sliding on the reference guides (20) and compress the cam tensioner spring (22) (FIG. 5). Lastly, when cams (18, 19) are sufficiently pushed, they sit on the slots provided on the reference guides (20) and the headrest is brought to use position (FIG. 11).

Transition of the headrest to non-use position can be described as follows:

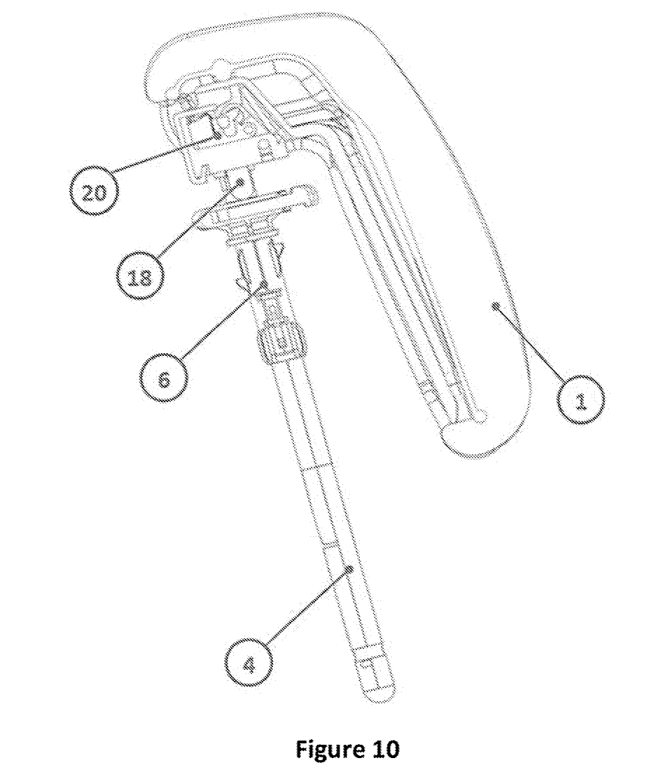

When the passenger lowers the headrest downward, right and left cams (18, 19) being in contact with the headrest cartridges (6) and compressed by the cam tensioner springs (22) move away from the headrest cartridges (6) and simultaneously cam tensioner spring (22) move by the effect of the compression in the channel thereof provided on the body (7) (on the slot provided on the headrest reference guide (20)) (FIG. 5). Said movement continues until the cams (18, 19) are freed from the slot of the reference guide (20) (FIG. 10).

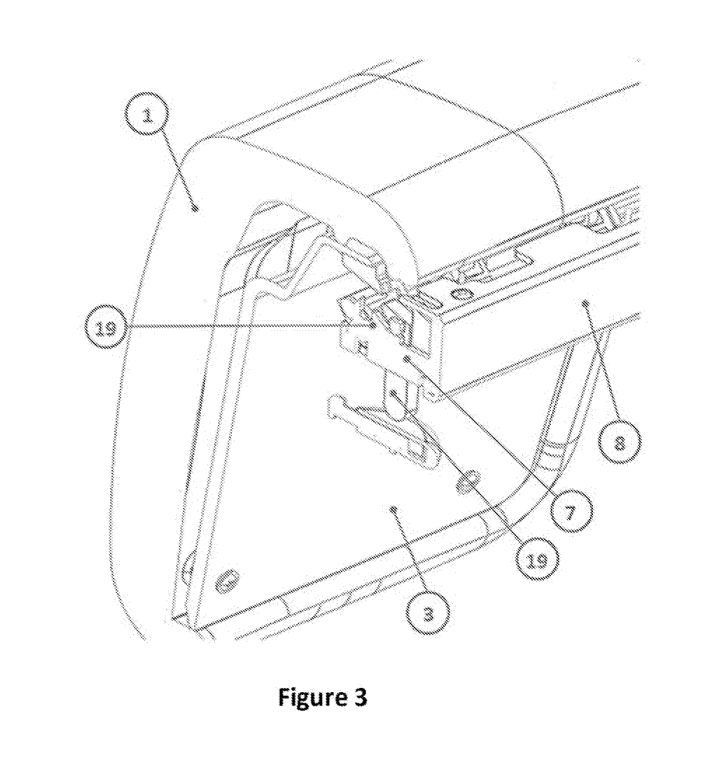

When the cams (18, 19) are freed from the slot and sit on the upper surface of the reference guide (20) by the effect of the cam tensioner springs (22), simultaneously, the headrest again moves to the non-use position by the effect of the right and left headrest drive springs (15, 16) (FIG. 3, FIG. 10).

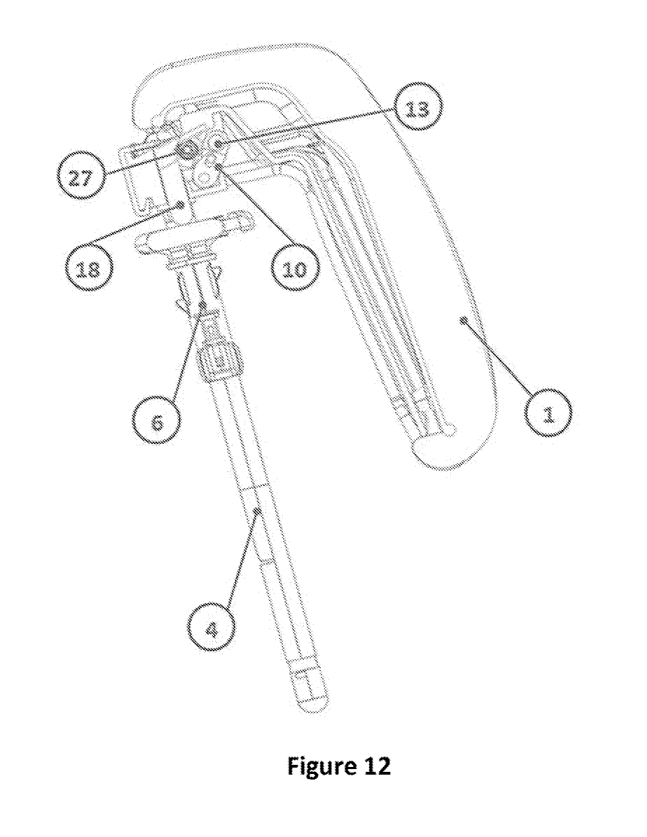

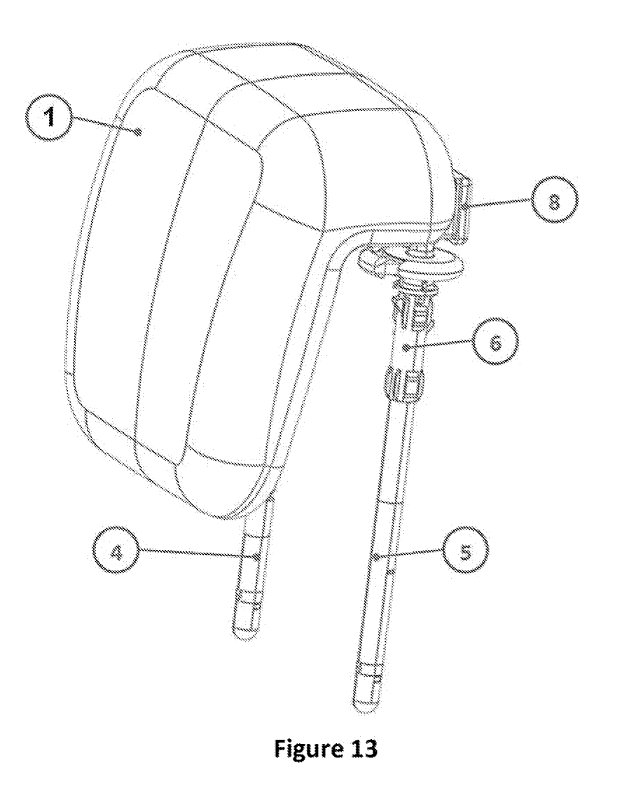

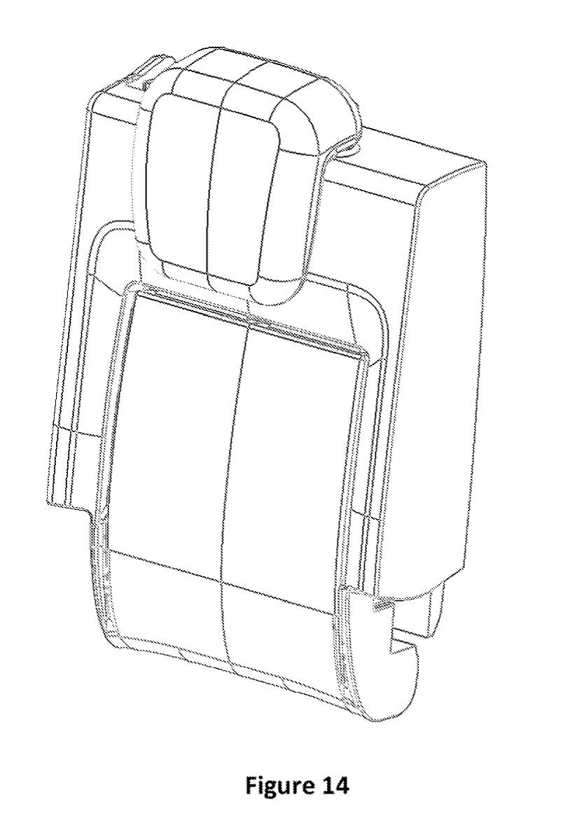

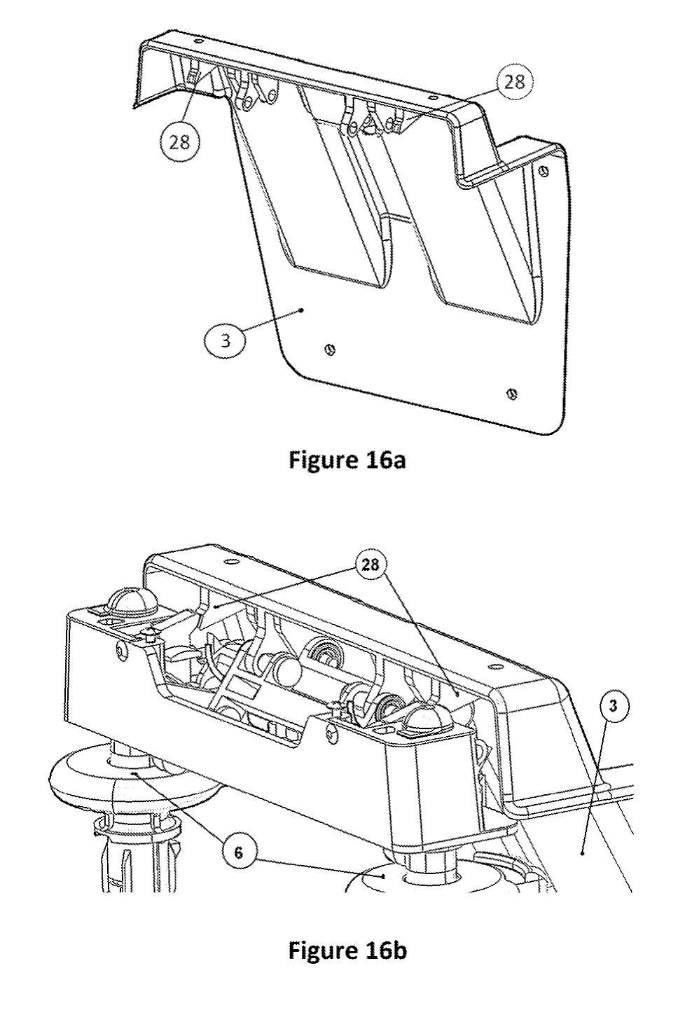

When the passenger applies pressure to the headrest in non-use position with their back, the stoppers (29) provided in the headrest prevent closing of the headrest and maintain functionality thereof (FIG. 12, FIG. 16).

1. Rear headrest mechanism for passenger seats comprising at headrest foam, an upper headrest plastic, a lower headrest plastic, right and left headrest shafts used for setting the course of the headrest, headrest cartridge used for guiding the movement of the right and left headrest shafts and enabling mounting of the headrest to the seat, body protecting the headrest mechanism from external impacts, wherein it comprises the following:
front and rear connecting rods for moving the headrest;
right and left cams providing the transition of the headrest between the use positions;
at least one reference guide having the geometry for keeping the right and left cams in non-use position;
at least one reference guide pin enabling relative movement of the reference guide with the front and rear connecting rods; and
a cam tensioner spring enabling keeping the right and left cams so as to constantly bear against the reference guide.

2. Rear headrest mechanism according to claim 1, wherein it comprises a rear cover preventing the headrest to be seen in non-use position by confining the mechanism into the body.

3. Rear headrest mechanism according to claim 1, wherein it comprises right and left headrest drive springs for enabling the headrest to move to non-use position when the right and left cams are freed from the reference guide.

4. Rear headrest mechanism according to claim 1, wherein it comprises a front connecting rod central pin as the center of rotation of the front connecting rod.

5. Rear headrest mechanism according to claim 1, wherein a front connecting rod headrest connection pin comprises the center point on which the headrest and the front connecting rod rotate around each other.

6. Rear headrest mechanism according to claim 1, wherein a rear connecting rod headrest connection pin comprises the center point on which the headrest and the front connecting rod rotate around each other.

7. Rear headrest mechanism according to claim 1, wherein it comprises at least one rear connecting rod central pin serving as the center of rotation of the rear connecting rod.
